(19) United States
(12) Patent Application Publication
(10) Pub. No.: US 2024/0005497 A1
(43) Pub. Date: Jan. 4, 2024

(54) IMAGE PROCESSING APPARATUS

(71) Applicant: CANON MEDICAL SYSTEMS CORPORATION, Otawara-shi (JP)

(72) Inventor: Guang Yi ONG, Nasushiobara (JP)

(73) Assignee: CANON MEDICAL SYSTEMS CORPORATION, Otawara-shi (JP)

(21) Appl. No.: 18/346,534

(22) Filed: Jul. 3, 2023

(30) Foreign Application Priority Data
Jul. 4, 2022 (JP) 2022-108007

(51) Int. Cl. G06T 7/00

(52) U.S. Cl. CPC G06T 7/0012; G06T 2207/30012; G06T 2207/20101; G06T 2200/24; G06T 2207/10081

(57) ABSTRACT

An image processing apparatus according to the present embodiment comprises processing circuitry configured to acquire a medical image regarding a spine including a plurality of vertebrae, receive, from a user, an input operation of editing a spine number allocated to each of the vertebrae in the medical image, and correct the spine number other than the spine number edited based on the received input operation.

### CROSS REFERENCE TO RELATED APPLICATIONS

This application is based upon and claims the benefit of priority from the prior Japanese Patent Application No. 2022-108007, filed on Jul. 4, 2022, the entire contents of which are incorporated herein by reference.

### FIELD

Embodiments described in the present specification and drawings relate generally to an image processing apparatus.

### BACKGROUND

Conventionally, a user confirms the presence or absence of damage or a lesion of a vertebra by interpreting a computed tomography (CT) image regarding a spine including a plurality of vertebrae acquired by an X-ray CT device. When confirming the presence or absence of damage or a lesion of the vertebra, the user needs to recognize each vertebra in order to identify the vertebra with the damage or lesion. However, since each vertebra in the spine has a similar structure, it is a burden on the user to recognize each vertebra while confirming the presence or absence of damage or lesion of the vertebra.

In recent years, in order to reduce a burden on a user, a technique of detecting each vertebra in a CT image by image analysis and allocating a spine number to each vertebra has been used. For example, in this image analysis, by anatomical landmark detection (Hereinafter referred to as ALD) that detects an anatomical landmark, which is a characteristic local structure in the human body, a feature point of each vertebra included in the CT image is detected, and a spine number is allocated to each vertebra based on the detected feature point of each vertebra.

However, depending on the image quality of the CT image, the accuracy of the image analysis is low, and thus, there is a case where an incorrect spine number is allocated to the vertebra, or a case where the vertebra cannot be detected in the image analysis and the spine number is not allocated to the vertebra. Furthermore, these problems similarly occur not only in the CT image but also in various medical images such as a magnetic resonance (MR) image acquired by a magnetic resonance imaging (MRI) device. For this reason, it is desired to be able to easily edit the spine number, such as modifying to allocate a correct spine number to the vertebra when an incorrect spine number is allocated to the vertebra, or adding a spine number when no spine number is allocated to the vertebra.

### BRIEF DESCRIPTION OF THE DRAWINGS

FIG. 1 is a block diagram illustrating an example of a configuration of an image processing system according to a first embodiment;

FIG. 2 is a diagram schematically illustrating a sagittal image representing a structure of a spine;

FIG. 3 is a diagram schematically illustrating an axial image representing a shape of a vertebra in a cervical spine;

FIG. 4 is a diagram schematically illustrating an axial image representing a shape of a vertebra in a thoracic vertebra;

FIG. 5 is a diagram schematically illustrating an axial image illustrating a shape of a vertebra in a lumbar vertebra;

FIG. 6 is a block diagram illustrating an example of a configuration of an image processing apparatus according to the first embodiment;

FIG. 7 is a flowchart diagram for explaining contents of addition processing executed by the image processing apparatus according to the first embodiment;

FIG. 8 is a flowchart diagram for explaining contents of the addition processing executed by the image processing apparatus according to the first embodiment;

FIG. 9 is a diagram illustrating an example of a CT image displayed on a display of the image processing apparatus according to the first embodiment;

FIG. 10 is a diagram illustrating an example of an input operation of adding a spine number received from a user with respect to a CT image displayed on the display of the image processing apparatus according to the first embodiment;

FIG. 11 is a diagram illustrating an example of a CT image to which a spine number has been added in the image processing apparatus according to the first embodiment;

FIG. 12 is a diagram illustrating an example of a CT image in a case where there is a vacancy in the spine number in the image processing apparatus according to the first embodiment;

FIG. 13 is a diagram illustrating an example of a CT image displayed on the display in a case where a designated position is located at a boundary between different regions in the spine in the image processing apparatus according to the first embodiment;

FIG. 14 is a diagram illustrating an example of an input operation of adding a spine number received from a user to a CT image in a case where a designated position is located at a boundary between different regions in the spine in the image processing apparatus according to the first embodiment;

FIG. 15 is a diagram illustrating an example of a CT image in which a plurality of options is displayed in a case where a designated position is located at a boundary between different regions in the spine in the image processing apparatus according to the first embodiment;

FIG. 16 is a flowchart diagram for explaining contents of deletion processing executed by an image processing apparatus according to a second embodiment;

FIG. 17 is a flowchart diagram for explaining contents of the deletion processing executed by the image processing apparatus according to the second embodiment;

FIG. 18 is a diagram illustrating an example of a CT image displayed on a display of the image processing apparatus according to the second embodiment;

FIG. 19 is a diagram illustrating an example of an input operation of deleting a spine number received from a user with respect to a CT image displayed on the display of the image processing apparatus according to the second embodiment;

FIG. 20 is a diagram illustrating an example of a CT image from which the spine number has been deleted in the image processing apparatus according to the second embodiment;

FIG. 21 is a diagram illustrating an example of a CT image displayed on the display in a case where a designated position is located at a boundary between different regions in the spine in the image processing apparatus according to the second embodiment;

FIG. 22 is a diagram illustrating an example of an input operation of deleting a spine number received from a user with respect to a CT image in a case where a designated position is located at a boundary between different regions in the spine in the image processing apparatus according to the second embodiment;

FIG. 23 is a diagram illustrating an example of a CT image in which a plurality of options is displayed in a case where a designated position is located at a boundary between different regions in the spine in the image processing apparatus according to the second embodiment;

FIG. 24 is a flowchart diagram for explaining contents of movement processing executed by an image processing apparatus according to a third embodiment;

FIG. 25 is a diagram illustrating an example of a CT image displayed on a display of the image processing apparatus according to the third embodiment;

FIG. 26 is a diagram illustrating an example of an input operation of moving a spine number received from a user with respect to a CT image displayed on the display of the image processing apparatus according to the third embodiment;

FIG. 27 is a diagram illustrating an example of a selection screen displayed on a CT image displayed on the display of the image processing apparatus according to the third embodiment; and

FIG. 28 is a diagram illustrating an example of a CT image in which a selected spine number and an updated spine number are displayed in the image processing apparatus according to the third embodiment.

### DETAILED DESCRIPTION

Hereinafter, respective embodiments of the image processing apparatus will be described with reference to the accompanying drawings. In the embodiments below, the same reference signs are given for identical components in terms of configuration and function, and duplicate description is omitted.

### First Embodiment

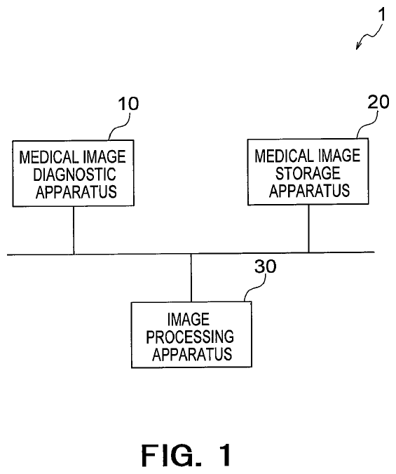

FIG. 1 is a block diagram illustrating an example of a configuration of an image processing system according to a first embodiment. As illustrated in FIG. 1, an image processing system 1 according to the present embodiment includes a medical image diagnostic apparatus 10, a medical image storage apparatus 20, and an image processing apparatus 30. The medical image diagnostic apparatus 10, the medical image storage apparatus 20, and the image processing apparatus 30 are communicably connected via an in-hospital network by a dedicated line in a hospital. Note that the medical image diagnostic apparatus 10, the medical image storage apparatus 20, and the image processing apparatus 30 may be communicably connected to each other via a network via a public line such as the Internet. Furthermore, the image processing apparatus 30 according to the present embodiment is configured separately from the medical image diagnostic apparatus 10, but the image processing apparatus 30 may be configured integrally with the medical image diagnostic apparatus 10.

The medical image diagnostic apparatus 10 captures an image of a subject and acquires a medical image. Then, the medical image diagnostic apparatus 10 transmits the acquired medical image to the medical image storage apparatus 20 or the image processing apparatus 30 via the in-hospital network. For example, the medical image diagnostic apparatus 10 is an X-ray CT apparatus, an MRI apparatus, or the like. In the following description, an example will be described in which the medical image diagnostic apparatus 10 is an X-ray CT apparatus, and the medical image is a CT image regarding a spine including a plurality of vertebrae acquired by the X-ray CT apparatus.

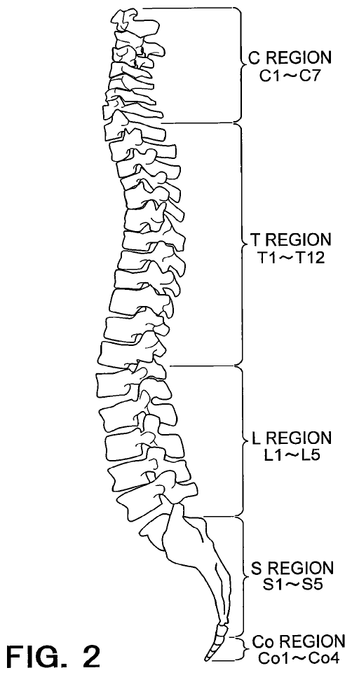

Here, the structure of the spine and the shape of the vertebrae in each region of the spine will be described in detail with reference to FIGS. 2 to 5. FIG. 2 is a diagram schematically illustrating a sagittal image representing the structure of the spine. As illustrated in FIG. 2, the spine includes, from the head side, five regions of a C region which is a region of cervical vertebrae, a T region which is a region of thoracic vertebrae, an L region which is a region of lumbar vertebrae, an S region which is a region of sacral vertebrae, and a Co region which is a region of coccygeal vertebrae. The spine including these five regions includes a plurality of vertebrae, each vertebra being anatomically allocated a spine number. The cervical vertebrae generally include seven vertebrae, and spine numbers C1 to C7 are allocated to each vertebra of the cervical vertebrae in order from the head side. The thoracic vertebrae generally include 12 vertebrae, and spine numbers T1 to T12 are allocated to each vertebra of the thoracic vertebrae in order from the head side. The lumbar vertebrae generally include five vertebrae, and spine number L1 to L5 are allocated to each vertebra of the lumbar vertebrae in order from the head side. The sacral vertebrae generally include five vertebrae, and spine numbers S1 to S5 are allocated to each vertebra of the sacral vertebrae in order from the head side. The coccygeal vertebrae generally include four vertebrae, and spine numbers Co1 to Co4 are allocated to each vertebra of the coccygeal vertebrae in order from the head side.

Note that the cervical vertebrae are not limited to seven vertebrae, but may be eight vertebrae. Therefore, when the cervical vertebrae include eight vertebrae, spine numbers C1 to C8 are allocated to the eight vertebrae in order from the head side. Furthermore, the lumbar vertebrae are not limited to five vertebrae, and may be four or six vertebrae. Therefore, when the lumbar vertebrae include four or six vertebrae, spine numbers L1 to L4 or spine numbers L1 to L6 are allocated to the four or six vertebrae in order from the head side. Moreover, the coccygeal vertebrae are not limited to four vertebrae, and may be composed of three or five vertebrae. Therefore, when the coccygeal vertebrae include three or five vertebrae, spine numbers Co1 to Co3 or spine numbers Co1 to Co5 are allocated to the three or five vertebrae in order from the head side.

Furthermore, the sacral vertebrae are not limited to five vertebrae, and the five vertebrae may be fused to form one sacrum. Therefore, when the sacral vertebrae are fused to form one sacrum, a spine number S or a spine number S1 is allocated to the sacrum. Moreover, the coccygeal vertebrae are not limited to including 3 to 5 vertebrae, and the 3 to 5 vertebrae may be fused to form one coccyx. Therefore, when the coccygeal vertebrae are fused to form one coccyx, a spine number Co or a spine number Co1 is allocated to the coccyx.

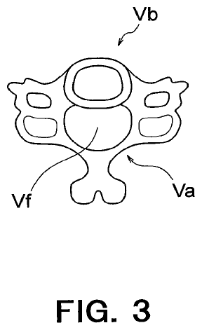

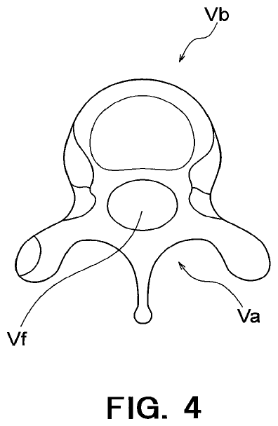

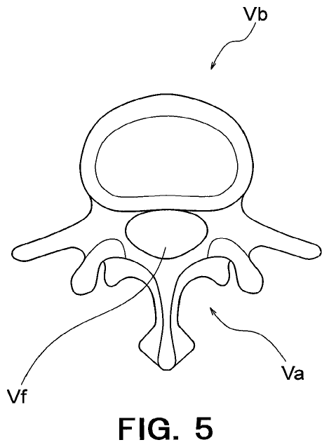

FIGS. 3 to 5 are diagrams schematically illustrating axial images representing the shape of the vertebrae in the respective regions of the cervical vertebrae, the thoracic vertebrae, and the lumbar vertebrae. FIG. 3 is an axial image illustrating the shape of a vertebra in the cervical vertebrae. FIG. 4 is an axial image illustrating the shape of a vertebra in the thoracic vertebrae. FIG. 5 is an axial image illustrating the shape of a vertebra in the lumbar vertebrae. As illustrated in FIGS. 3 to 5, the vertebra constituting each of the cervical vertebrae, the thoracic vertebrae, and the lumbar vertebrae include a vertebral body Vb, a vertebral arch Va, a vertebral foramen Vf, and the like. The vertebral body Vb is a columnar portion located in front (ventral side) of the vertebra. The vertebral arch Va is an arched portion located at the back (dorsal side) of the vertebra. The vertebral foramen Vf is a space located between the vertebral body Vb and the vertebral arch Va.

Returning to FIG. 1, the medical image storage apparatus 20 stores medical images acquired by the medical image diagnostic apparatus 10, various images generated by the image processing apparatus 30, and the like. Furthermore, the medical image storage apparatus 20 transmits stored CT image, various images, and the like to the medical image diagnostic apparatus 10 or to the image processing apparatus 30 via the in-hospital network. For example, the medical image storage apparatus 20 is an image server such as a picture archiving and communication system (PACS).

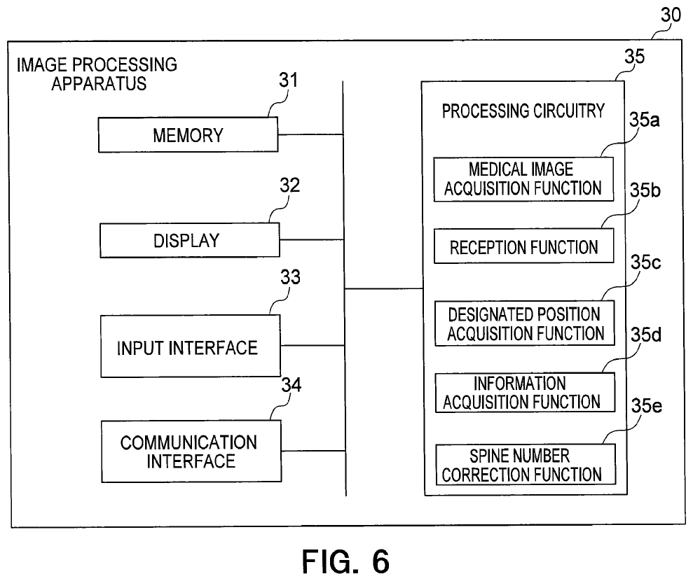

The image processing apparatus 30 executes various types of image processing on a CT image that is a medical image acquired by the medical image diagnostic apparatus 10 and a CT image transmitted from the medical image storage apparatus 20. FIG. 6 is a block diagram illustrating an example of a configuration of the image processing apparatus 30 according to the present embodiment. As illustrated in FIG. 6, the image processing apparatus 30 according to the present embodiment includes a memory 31, a display 32, an input interface 33, a communication interface 34, and a processing circuitry 35.

The memory 31 is realized by, for example, a random access memory (RAM), a semiconductor memory element such as a flash memory, a hard disk, an optical disk, or the like. In the present embodiment, the memory 31 stores, for example, various types of information such as a CT image acquired by the medical image diagnostic apparatus 10, a CT image transmitted from the medical image storage apparatus 20, and various images generated by the image processing apparatus 30.

The display 32 displays various images and information. For example, the display 32 displays a graphical user interface (GUI) or the like for receiving various operations from the user. In the present embodiment, the display 32 is configured by, for example, a liquid crystal display, a cathode ray tube (CRT) display, or the like.

The input interface 33 receives various input operations from the user, converts the received input operations into electrical signals, and outputs the electrical signals to the processing circuitry 35. The input interface 33 is realized by, for example, a mouse, a keyboard, a trackball, a manual switch, a foot switch, a button, a joystick, or the like.

The communication interface 34 implements various information communication protocols according to the form of the in-hospital network. The communication interface 34 realizes communication with other apparatuses via the in-hospital network according to the various protocols. In the present embodiment, the image processing apparatus 30 is connected to an in-hospital network via the communication interface 34, and communication with the medical image diagnostic apparatus 10 and the medical image storage apparatus 20 is realized.

The processing circuitry 35 is an arithmetic circuitry that performs various arithmetic operations. The processing circuitry 35 according to the present embodiment acquires a CT image in which a spine number is allocated to each vertebra and edits the spine number allocated to each vertebra by performing image analysis on the CT image by another system. Note that the processing circuitry 35 may perform image analysis on the CT image acquired by the medical image diagnostic apparatus 10 or the CT image transmitted from the medical image storage apparatus 20, and allocate a spine number to each vertebra.

Therefore, the processing circuitry 35 according to the present embodiment has a medical image acquisition function 35a, a reception function 35b, a designated position acquisition function 35c, an information acquisition function 35d, and a spine number correction function 35e. The medical image acquisition function 35a corresponds to a medical image acquisition unit according to the present embodiment, the reception function 35b corresponds to a reception unit according to the present embodiment, the designated position acquisition function 35c corresponds to a designated position acquisition unit according to the present embodiment, the information acquisition function 35d corresponds to an information acquisition unit according to the present embodiment, and the spine number correction function 35e corresponds to a spine number correction unit according to the present embodiment.

In the embodiment illustrated in FIG. 6, each processing function performed by the medical image acquisition function 35a, the reception function 35b, the designated position acquisition function 35c, the information acquisition function 35d, and the spine number correction function 35e is stored in the memory 31 in the form of a program executable by a computer. The processing circuitry 35 is a processor that realizes a function corresponding to each program by reading and executing the program from the memory 31. In other words, the processing circuitry 35 in a state of reading each program has each function illustrated in the processing circuitry 35 of FIG. 6. Note that, in FIG. 6, it has been described that the medical image acquisition function the reception function 35b, the designated position acquisition function 35c, the information acquisition function 35d, and the spine number correction function 35e are realized by a single processing circuitry but these functions may be realized by combining a plurality of independent processors to configure the processing circuitry 35 and executing a program by each processor.

The medical image acquisition function 35a acquires a CT image from the medical image diagnostic apparatus 10 or the medical image storage apparatus 20. Furthermore, in a case where a CT image is stored in the memory 31 of the image processing apparatus 30, the medical image acquisition function 35a acquires the CT image from the memory 31 of the image processing apparatus 30. This CT image is an image regarding a spine including a plurality of vertebrae.

The reception function 35b receives, from the user, an input operation of editing the spine number allocated to each of the vertebrae in the CT image. The input operation of editing the spine number is an input operation of manually editing the spine number by the user or an input operation of automatically editing the spine number by the user. The input operation of manually editing the spine number is, for example, an input operation of directly editing the spine number by the user via the input interface 33. The input operation of automatically editing the spine number is, for example, an input operation in which the user specifies a vertebra for editing the spine number via the input interface 33. The reception function 35b edits the spine number based on the received input operation of editing the spine number. Editing the spine number means adding the spine number to the vertebra of the CT image, deleting the spine number allocated to each vertebra of the CT image, or moving the spine number allocated to each vertebra of the CT image to a position of another vertebra.

The designated position acquisition function 35c acquires a designated position of the CT image designated by an input operation from the user received by the reception function 35b.

The information acquisition function 35d acquires anatomical landmark information in a vertebra at the designated position and/or in a vertebra adjacent to the vertebra at the designated position based on the designated position acquired by the designated position acquisition function 35c. The anatomical landmark information is information including information regarding anatomical landmarks, positions of the anatomical landmarks, information regarding probabilities of the anatomical landmarks, information regarding spine numbers in the anatomical landmarks, and the like. The anatomical landmarks, the information regarding the positions of the anatomical landmarks, the information regarding the probabilities of the anatomical landmarks, and the information regarding the spine numbers in the anatomical landmarks may all be included in the anatomical landmark information, or at least one of them may be included in the anatomical landmark information. The information regarding the position of the anatomical landmark is, for example, XYZ coordinates where the anatomical landmark is located in a CT image.

The spine number correction function 35e corrects the spine number allocated to the vertebra other than the spine number edited by the reception function 35b based on the input operation of correcting the spine number received by the reception function 35b.

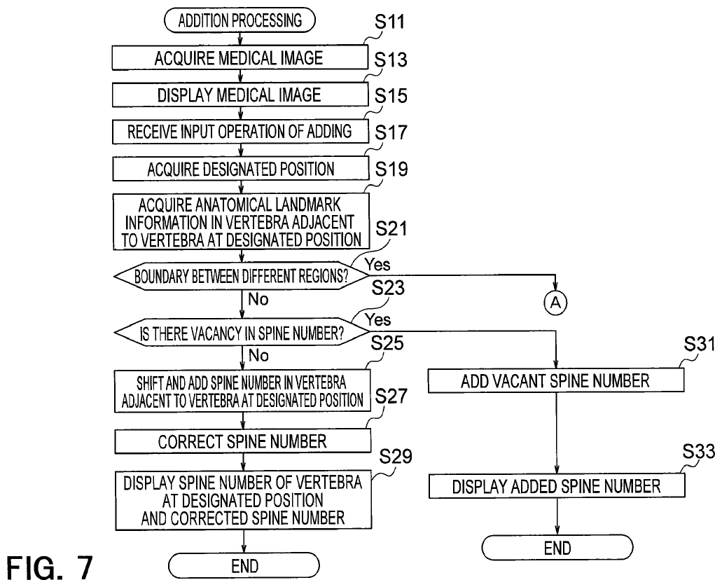

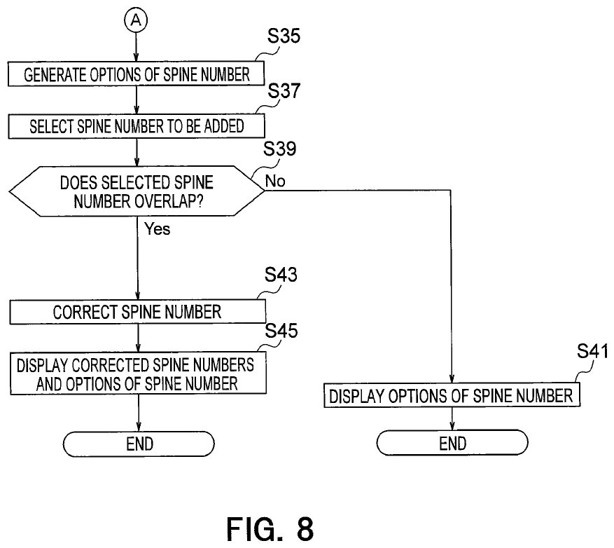

FIGS. 7 and 8 are flowchart diagrams for explaining the contents of the addition processing executed by the image processing apparatus 30 according to the present embodiment. In this addition processing, an input operation of adding a spine number is received from the user, a designated position designated by the input operation of adding the spine number received from the user is acquired, anatomical landmark information in the vertebra adjacent to the vertebra of the acquired designated position is acquired, and the spine number is added to the designated position based on the input operation of adding the spine number and the anatomical landmark information in the vertebra adjacent to the vertebra of the designated position. For example, this addition processing is processing executed when the user activates an edit program for editing the spine number allocated to the CT image.

First, as illustrated in FIG. 7, the image processing apparatus 30 acquires a medical image (step S11). The processing of acquiring the medical image is realized by the medical image acquisition function 35a in the processing circuitry 35. Specifically, the image processing apparatus 30 acquires the CT image to which the spine number is allocated from the medical image diagnostic apparatus 10 or the medical image storage apparatus 20 via the communication interface 34. Note that the image processing apparatus 30 may acquire the CT image to which the spine number is allocated from another apparatus other than the medical image diagnostic apparatus 10 and the medical image storage apparatus 20. As described above, in a case where the anatomical landmark information including the spine number created by another system is acquired from another apparatus such as the medical image diagnostic apparatus 10 or the medical image storage apparatus 20, and the CT image to which the spine number is allocated is acquired, the image processing apparatus 30 acquires the spine number from a file stored in a digital imaging and communication in medicine (DICOM) format, a Java (registered trademark) script object notation (JSON) format, or another data format. This file includes information such as information regarding anatomical landmarks, positions of the anatomical landmarks, information regarding probabilities of the anatomical landmarks, and information regarding spine numbers in the anatomical landmarks.

Furthermore, the CT image may be directly acquired by the medical image acquisition function 35a in the processing circuitry 35 via the communication interface 34, or the CT image acquired via the communication interface 34 may be temporarily stored in the memory 31 and then acquired from the memory 31 by the medical image acquisition function 35a in the processing circuitry 35. Moreover, in step S11, the CT image to which the spine number is allocated is acquired, but the image processing apparatus 30 may allocate the spine number after acquiring the CT image.

Next, as illustrated in FIG. 7, the image processing apparatus 30 displays a medical image (step S13). The processing of displaying the medical image is realized by the medical image acquisition function 35a in the processing circuitry 35. Specifically, the image processing apparatus 30 displays the CT image acquired in step S11 on the display 32.

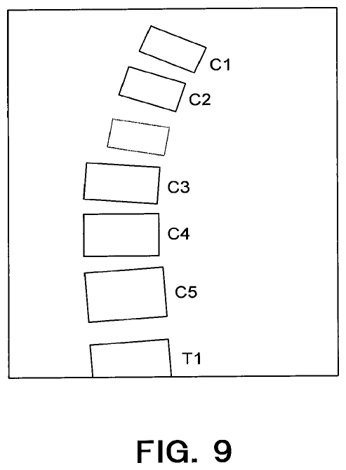

FIG. 9 is a diagram illustrating an example of a CT image displayed on the display 32 of the image processing apparatus 30 according to the present embodiment. As illustrated in FIG. 9, the CT image displayed on the image processing apparatus 30 according to the present embodiment is a CT image regarding a spine including a plurality of vertebrae. In this CT image, for example, a spine number is allocated to each vertebra by detecting a physical feature of a subject by ALD and specifying each vertebra. Specifically, as illustrated in FIG. 9, spine numbers C1 to C5 and T1 are allocated to each vertebra of the displayed CT image. Note that, in the present embodiment, the image processing apparatus 30 allocates the spine number to each vertebra by performing ALD on the CT image, but the method of allocating the spine number to each vertebra is not limited thereto. That is, a method of allocating the spine number to each vertebra is arbitrary, and the image processing apparatus 30 may perform various image analysis on the CT image to allocate the spine number.

Next, as illustrated in FIG. 7, the image processing apparatus 30 receives an input operation of adding a spine number from the user (step S15). The processing of receiving the input operation of adding the spine number is realized by the reception function 35b in the processing circuitry 35. Specifically, the image processing apparatus 30 receives an input operation of adding the spine number in the CT image displayed on the display 32 in step S13 from the user via the input interface 33.

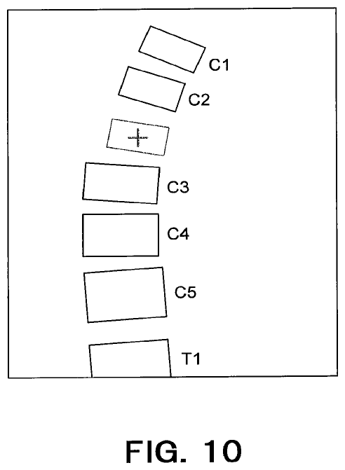

FIG. 10 is a diagram illustrating an example of the input operation of adding the spine number received from the user to the CT image displayed on the display 32 of the image processing apparatus 30 according to the present embodiment. As illustrated in FIG. 10, the image processing apparatus 30 receives an input operation of adding a plus sign to a position between a vertebra to which the spine number C2 is allocated and a vertebra to which the spine number C3 is allocated in the CT image displayed on the display 32 from the user via a mouse or the like which is the input interface 33. That is, the plus sign added to the CT image illustrated in FIG. 10 indicates a position where the input operation to add the spine number is received from the user.

Note that, in step S15, the image processing apparatus 30 receives the input operation of adding the spine number from the user by adding the plus sign to the CT image, but the input operation of adding the spine number is not limited to the case of adding the plus sign to the CT image. That is, the input operation of adding the spine number is arbitrary, and for example, the image processing apparatus 30 may receive the input operation of adding the spine number from the user by the input operation of right clicking the mouse as the input interface 33.

Furthermore, in a case where the input operation of adding the spine number is received from the user in step S15, the image processing apparatus 30 may detect a range of the vertebra in a region around the position where the input operation of adding the spine number is received from the user. Specifically, the image processing apparatus 30 may perform image processing based on the gradation of the pixel at the position where the input operation of adding the spine number has been received, and in a region around the position where the input operation of adding the spine number has been received, a region of gradation within a range of a reference range based on the gradation of the pixel at the position where the input operation of adding the spine number has been received may be detected as the range of the vertebra.

Next, as illustrated in FIG. 7, the image processing apparatus 30 acquires the designated position (step S17). The processing of acquiring the designated position is realized by the designated position acquisition function 35c in the processing circuitry 35. Specifically, the image processing apparatus 30 acquires information regarding the position of the designated position designated by the input operation of adding the spine number received from the user in step S15. The information regarding the position of the designated position is, for example, XYZ coordinates of the designated position in the CT image.

Next, as illustrated in FIG. 7, the image processing apparatus 30 acquires anatomical landmark information in the vertebra adjacent to the vertebra at the designated position (step S19). The processing of acquiring the anatomical landmark information is realized by the information acquisition function 35d in the processing circuitry 35. Specifically, the image processing apparatus 30 acquires the anatomical landmark information in the vertebra adjacent to the vertebra at the designated position based on the information regarding the position of the designated position acquired in step S17. More specifically, in the example illustrated in FIG. 10, the image processing apparatus 30 acquires the anatomical landmark information in the vertebra to which the spine number C2 is allocated, which is located on the head side of the vertebra at the designated position represented by the plus sign, and the anatomical landmark information in the vertebra to which the spine number C3 is allocated, which is located on the lower limb side of the vertebra at the designated position represented by the plus sign.

Next, as illustrated in FIG. 7, the image processing apparatus 30 determines whether or not the designated position is located at a boundary between different regions in the spine (step S21). The processing of determining whether or not to be located at the boundary between the different regions is realized by the reception function 35b in the processing circuitry 35. Specifically, the image processing apparatus 30 determines whether or not the designated position acquired in step S17 is located at the boundary between the different regions based on the anatomical landmark information in the vertebra adjacent to the vertebra at the designated position acquired in step S19. More specifically, the reception function 35b is determined whether the spine numbers in the anatomical landmark information of the respective vertebrae located on the head side and the lower limb side of the vertebra at the designated position indicate the same region or different regions.

Then, in step S21, in a case where the designated position is not located at the boundary between the different regions in the spine (step S21: No), that is, in a case where the spine numbers in the anatomical landmark information of the vertebra adjacent to the vertebra at the designated position indicate the same region as illustrated in FIG. 10, the image processing apparatus 30 determines whether or not there is a vacancy in the spine number (step S23). The processing of determining whether or not there is a vacancy in the spine number is realized by the reception function 35b in the processing circuitry 35. Specifically, the image processing apparatus 30 determines whether or not there is a vacancy in the spine number based on the anatomical landmark information in the vertebra adjacent to the vertebra at the designated position acquired in step S19. More specifically, the image processing apparatus 30 determines whether or not there is a vacancy in the spine number based on the spine number in the anatomical landmark information of the vertebra adjacent to the vertebra at the designated position.

Then, in step S23, when there is no vacancy in the spine number (step S23: No), the image processing apparatus 30 shifts and adds the spine number in the vertebra adjacent to the vertebra at the designated position (step S25). The processing of shifting and adding the spine number is realized by the reception function 35b in the processing circuitry 35. Specifically, the image processing apparatus 30 shifts and adds the spine number in the vertebra adjacent to the vertebra at the designated position as the spine number of the vertebra at the designated position based on the anatomical landmark information in the vertebra adjacent to the vertebra at the designated position. More specifically, in the example illustrated in FIG. 10, the image processing apparatus 30 adds the spine number C3 to the vertebra at the designated position by shifting the spine number C3 in the vertebra located on the lower limb side of the vertebra at the designated position by one in a head-side direction as the spine number of the vertebra at the designated position.

Next, as illustrated in FIG. 7, the image processing apparatus 30 corrects the spine number (step S27). The processing of correcting the spine number is realized by the spine number correction function 35e in the processing circuitry 35. Specifically, in a case where the spine number is shifted in step S25, the image processing apparatus 30 corrects other spine numbers located on the side of the spine number overlapping with the spine number of the vertebra at the designated position with reference to the spine number of the vertebra at the added designated position, and within the same region as the spine number of the vertebra at the added designated position.

More specifically, since the image processing apparatus 30 has shifted and added the spine number C3 as the spine number of the vertebra at the designated position in step S25, in the C region in the same region as the spine number of the vertebra at the added designated position, the spine numbers allocated to the respective vertebrae in the example illustrated in FIG. 10 are C1, C2, C3, C3, C4, and C5 in order from the head side. That is, the spine number of the vertebra at the third designated position from the head side and the spine number of the vertebra in the C region fourth from the head side overlap at C3. Therefore, the image processing apparatus 30 compares the information regarding the position of the designated position with the information regarding the position of the anatomical landmark of the vertebra adjacent to the vertebra of the designated position, and since the spine numbers of the vertebrae at the positions close to the head side are C2 and C3, the image processing apparatus 30 determines that the probability that the spine number C3 of the fourth vertebra from the head side becomes C4 is high, and corrects the overlapping spine numbers and the other spine numbers C3, C4, and C5 located on the overlapping spine number side to C4, C5, and C6 in order from the head side with reference to the spine number C3 of the vertebra at the third designated position from the head side as a reference.

Note that, in step S27, the image processing apparatus 30 corrects the spine number by comparing the information regarding the position in the anatomical landmark information of the vertebra, but the method of correcting the spine number is not limited thereto. That is, a method of correcting the spine number is arbitrary, and for example, in a case where the spine numbers allocated to the respective vertebrae overlap, a selection screen for selecting the spine number may be generated to allow the user to select the spine number.

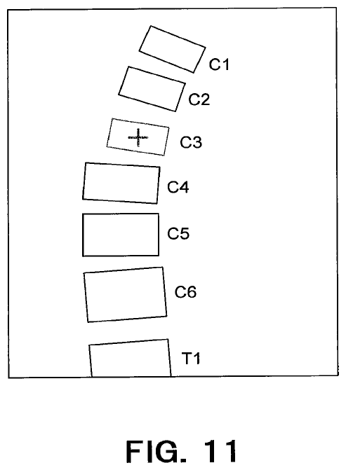

Next, as illustrated in FIG. 7, the spine number of the vertebra at the designated position and the corrected spine number are displayed (step S29). The processing of displaying the spine number of the vertebra at the designated position and the corrected spine number is realized by the spine number correction function 35e in the processing circuitry 35. Specifically, the image processing apparatus 30 displays the spine number added in step S25 and the spine number corrected in step S27 on the display 32. More specifically, as illustrated in FIG. 11, the image processing apparatus 30 displays the spine number C3 added to the vertebra at the designated position in step S25, and displays the spine numbers C4, C5, and C6 corrected in step S27 on the CT image displayed on the display 32. As a result, the addition processing ends.

On the other hand, in step S23, in a case where there is a vacancy in the spine number (step S23: Yes), the image processing apparatus 30 adds the vacant spine number (step S31). This processing of adding the vacant spine number is realized by the reception function 35b in the processing circuitry 35. Specifically, the image processing apparatus 30 adds the vacant spine number by allocating a vacant spine number to the vertebra at the designated position based on the spine number in the anatomical landmark information of the vertebra adjacent to the vertebra at the designated position as the spine number of the vertebra at the designated position.

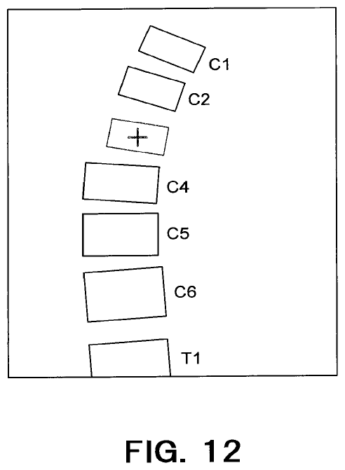

FIG. 12 is a diagram illustrating an example of a CT image in a case where there is a vacancy in the spine number in the image processing apparatus 30 according to the present embodiment. As illustrated in FIG. 12, spine numbers C1, C2, C4 to C6, and T1 are allocated to each vertebra of the CT image displayed on the display 32. The spine numbers of the vertebrae adjacent to the vertebra at the designated position indicated by the plus sign are C2 and C4. Therefore, the image processing apparatus 30 adds a spine number C3 that is a vacant spine number for the vertebra at the designated position.

Next, the image processing apparatus 30 displays the added spine number (step S33). The processing of displaying the added spine number is realized by the reception function 35b in the processing circuitry 35. Specifically, the image processing apparatus 30 displays the spine number added in step S31 on the display 32. More specifically, the image processing apparatus 30 displays, on the display 32, the spine number C3 added to the vertebra at the designated position in step S31. As a result, the addition processing ends.

On the other hand, in step S21 illustrated in FIG. 7, in a case where the designated position is located at the boundary between the different regions in the spine (step S21: Yes), that is, in a case where the spine numbers in the anatomical landmark information of the vertebra adjacent to the vertebra at the designated position indicate different regions, the image processing apparatus 30 generates options of the spine number as illustrated in FIG. 8 (step S35). The processing of generating the options of the spine number is realized by the reception function 35b in the processing circuitry 35. Specifically, the image processing apparatus 30 generates a plurality of options regarding the spine number of the vertebra at the designated position acquired in step S17 based on the anatomical landmark information in the vertebra adjacent to the vertebra at the designated position acquired in step S17.

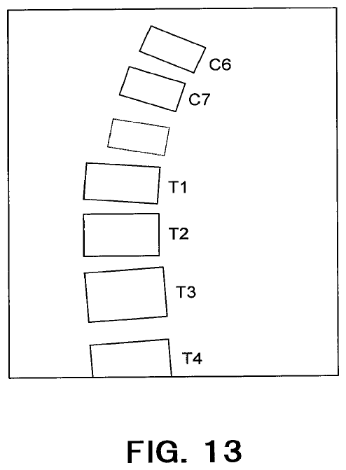

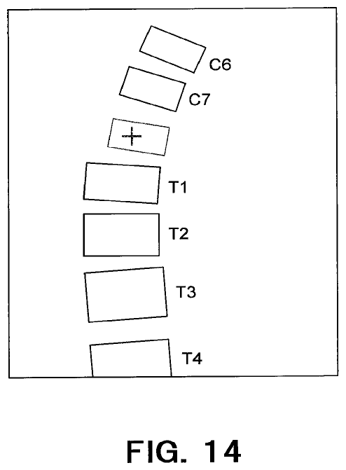

A case where the designated position according to the present embodiment is located at a boundary between different regions in the spine will be described with reference to FIGS. 13 and 14. FIG. 13 is a diagram illustrating an example of a CT image in a case where the designated position is located at the boundary between the different regions in the spine in the image processing apparatus 30 according to the present embodiment. FIG. 14 is a diagram illustrating an example of an input operation of adding the spine number received from the user to the CT image in a case where the designated position is located at the boundary between the different regions in the spine in the image processing apparatus 30 according to the present embodiment. As illustrated in FIG. 13, spine numbers C6, C7, and T1 to T4 are allocated to each vertebra of the CT image displayed on the display 32. Furthermore, as illustrated in FIG. 14, the image processing apparatus 30 receives an input operation of adding a spine number to a position between the spine number C7 and the spine number T1 from the user via a mouse or the like which is the input interface 33. In the example illustrated in FIG. 14, there is a possibility that the image processing apparatus 30 allocates the spine number C8 or the spine number T1 as the spine number of the vertebra at the designated position based on the input operation of adding the spine number received from the user and the anatomical landmark information in the vertebra adjacent to the vertebra at the designated position acquired in step S17. Therefore, in step S35, the image processing apparatus 30 generates options of the spine number C8 and the spine number T1 as a plurality of options of the spine number.

Note that the plurality of options regarding the spine number of the vertebra at the designated position generated in step S35 is not limited to two. That is, the number of the plurality of options for the spine number of the vertebra at the designated position to be generated is arbitrary, and three or more options may be generated.

Next, as illustrated in FIG. 8, the image processing apparatus 30 selects a spine number to be added (step S37). The processing of selecting the spine number to be added is realized by the reception function 35b in the processing circuitry 35. Specifically, the image processing apparatus 30 analyzes the CT image of the vertebra at the designated position acquired in step S17, thereby selecting the spine number to be added from the plurality of options generated in step S35. More specifically, as illustrated in FIGS. 3 to 5, the vertebral bodies Vb and the vertebral arches Va of the cervical vertebrae, the thoracic vertebrae, and the lumbar vertebrae have different sizes and shapes for respective regions of the cervical vertebrae, the thoracic vertebrae, and the lumbar vertebrae. Therefore, the size and/or shape of the vertebrae in each region of the C region, the T region, and the L region are different. Therefore, in step S37, the image processing apparatus 30 performs image analysis on the axial image to recognize which region of the C region, the T region, and the L region the vertebra at the designated position belongs to, and selects the spine number to be added.

Note that the image processing apparatus 30 selects the spine number to be added by analyzing the CT image at the designated position, but the method of selecting the spine number to be added is not limited thereto. That is, a method of selecting the spine number to be added is arbitrary. For example, the image processing apparatus 30 may select the spine number to be added by comparing the information regarding the position in the anatomical landmark information of the plurality of options with the information regarding the probability. The image processing apparatus 30 may present options of the spine number to the user as a selection screen, and may select the spine number by receiving an input operation regarding the selection of the user. The image processing apparatus 30 may present a list of the spine numbers to the user, and may select the spine number to be added by receiving an input operation regarding the selection of the user with respect to the presented list. The image processing apparatus 30 may display a text input box, and may cause the user to input the spine number to be added via the input interface 33, and may select the spine number to be added.

Next, as illustrated in FIG. 8, the image processing apparatus 30 determines whether or not the selected spine number overlaps (step S39). The processing of determining whether or not the selected spine number overlaps is realized by the spine number correction function 35e in the processing circuitry 35. Specifically, the image processing apparatus 30 determines whether or not the selected spine number overlaps based on the anatomical landmark information in the vertebra adjacent to the vertebra at the designated position acquired in step S19. More specifically, the image processing apparatus 30 determines whether or not the selected spine number overlaps with the spine number in a vertebra adjacent to the vertebra at the designated position.

Then, in a case where the selected spine number does not overlap (step S39: No), the image processing apparatus 30 displays the options of the spine number (step S41). This processing of displaying the options of the spine number is realized by the spine number correction function 35e in the processing circuitry 35. Specifically, the image processing apparatus 30 displays the options of the spine number generated in step S35 while highlighting the spine number selected in step S37. As a result, the addition processing ends.

On the other hand, in step S39, in a case where the selected spine number overlaps (step S39: Yes), the image processing apparatus 30 corrects the spine number (step S43). The processing of correcting the spine number is realized by the spine number correction function 35e in the processing circuitry 35. Specifically, the image processing apparatus 30 corrects the spine number located in the same region as the spine number selected in step S37.

More specifically, in the example illustrated in FIG. 14, in a case where the spine number T1 is selected in step S37 as the spine number of the vertebra at the designated position to be added, the spine numbers allocated to the vertebrae in the T region which is the same region as the selected spine number T1 are T1, T1, T2, T3, and T4. That is, the spine number of the first vertebra in the T region from the head side and the spine number of the second vertebra in the T region from the head side overlap at T1. Therefore, the image processing apparatus 30 compares the information regarding the position of the designated position with the information regarding the position of the anatomical landmark of the vertebra adjacent to the vertebra at the designated position, and since the spine number of the vertebra of the T region at the position close to the head side is T1, it is determined that the probability that the spine number of the second vertebra of the T region from the head side will be T2 is high, and the spine numbers T1, T2, T3, and T4 allocated to the vertebra of the T region that is the same region as the selected spine number T1 are corrected to T2, T3, T4, and T5 in order from the head side.

Next, as illustrated in FIG. 8, the image processing apparatus 30 displays the corrected spine numbers and the options of the spine number (step S45). The processing of displaying the corrected spine numbers and the options of the spine number is realized by the spine number correction function 35e in the processing circuitry 35. Specifically, the image processing apparatus 30 displays the spine number generated in step S37 and the spine numbers corrected in step S43 on the CT image while highlighting the spine number selected in step S37. As a result, the addition processing ends.

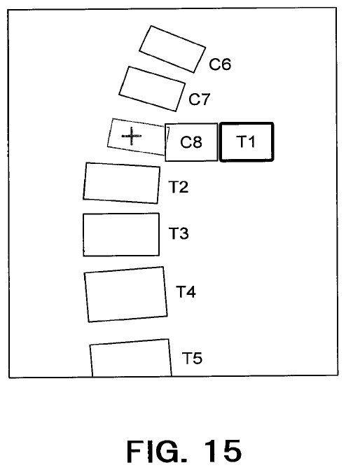

FIG. 15 is a diagram illustrating an example of a CT image in which a plurality of options is displayed in a case where the designated position is located at the boundary between the different regions in the spine in the image processing apparatus 30 according to the present embodiment. As illustrated in FIG. 15, on the display 32 of the image processing apparatus 30, options of the spine number C8 and the spine number T1 are displayed as the spine number of the vertebra at the designated position, and the option of the spine number T1 selected in step S37 is emphasized. That is, in the example illustrated in FIG. 15, since the spine number T1 is selected, the spine numbers of the T region located closer to the lower limb side than the spine number T1 are corrected and displayed.

As described above, according to the image processing apparatus 30 of the present embodiment, the image processing apparatus 30 acquires the medical image regarding the spine including the plurality of vertebrae, receives the input operation of editing the spine number allocated to each of the vertebrae of the acquired medical image from the user, acquires the designated position designated by the input operation of editing the spine number received from the user, acquires the anatomical landmark information in the vertebra at the designated position and/or in the vertebra adjacent to the vertebra at the designated position based on the acquired designated position, and edits the spine number based on the acquired anatomical landmark information. Therefore, the spine number can be easily edited. That is, in the present embodiment, the image processing apparatus 30 receives, from the user, an input operation of adding a spine number to a medical image regarding the spine including a plurality of vertebrae, acquires a designated position designated by the input operation of adding the spine number received from the user, acquires anatomical landmark information in the vertebra adjacent to the vertebra at the designated position based on the acquired designated position, and adds the spine number based on the acquired anatomical landmark information. Therefore, even in a case where the gradation of the medical image is low, the vertebra cannot be detected by ALD or the like, and the spine number is not allocated to the vertebra, the spine number can be added.

Note that, in the image processing apparatus 30 according to the first embodiment described above, the input operation of automatically adding the spine number is received from the user and the spine number is automatically added, but the image processing apparatus 30 according to the first embodiment may receive the input operation of manually adding the spine number from the user and manually add the spine number. Specifically, the image processing apparatus 30 may receive an input operation of manually adding the spine number from the user at an arbitrary position of the CT image displayed on the display 32, display a text input box at a position where the input operation in the CT image has been received, and manually add the spine number by the user inputting a text regarding the spine number via the input interface 33 into the displayed text input box.

### Second Embodiment

In the image processing apparatus 30 according to the first embodiment described above, the input operation of adding the spine number is received from the user, the designated position designated by the input operation of adding the spine number received from the user and the anatomical landmark information in the vertebra adjacent to the vertebra at the designated position is acquired, and the spine number is added based on the input operation of adding the spine number and the anatomical landmark information in the vertebra adjacent to the vertebra at the designated position, but the editing of the spine number is not limited to the case of adding the spine number. Therefore, in the second embodiment, an image processing apparatus 30 that receives an input operation of deleting a spine number from a user and deletes the spine number will be described. Hereinafter, portions different from the above-described first embodiment will be described. Note that the configuration of an image processing system 1 according to the present embodiment is similar to that in FIG. 1, and thus the description thereof will be omitted. Furthermore, since the configuration of the image processing apparatus 30 according to the present embodiment is similar to that in FIG. 2, the description thereof will be omitted.

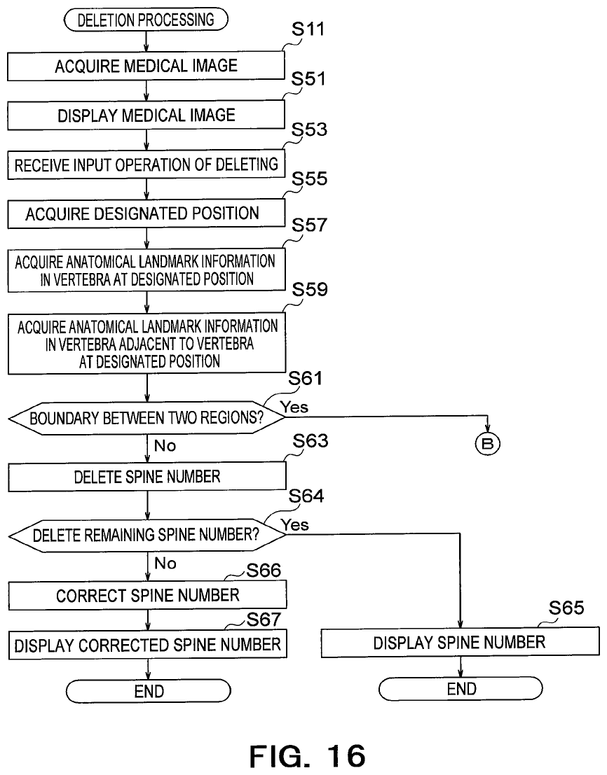

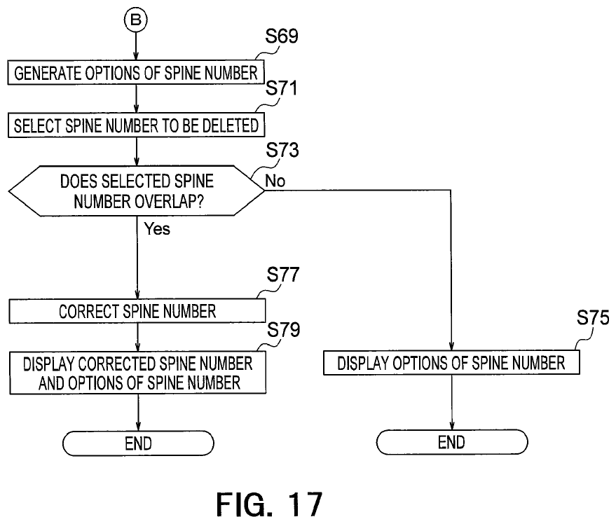

FIGS. 16 and 17 are flowchart diagrams for explaining the contents of the deletion processing executed by the image processing apparatus 30 according to the present embodiment, and are diagrams corresponding to FIGS. 7 and 8 in the above-described first embodiment. In this deletion processing, an input operation of deleting the spine number is received from the user, the designated position is acquired by the input operation of deleting the spine number received from the user, the anatomical landmark information in the vertebra at the designated position is acquired, and the spine number is deleted based on the input operation of deleting the spine number and the anatomical landmark information in the vertebra at the designated position. For example, this deletion processing is processing executed when the user activates an edit program for editing the spine number allocated to the CT image. Note that the processing in step S11 illustrated in FIG. 16 is similar to that in FIG. 7 in the above-described first embodiment, and thus description thereof is omitted.

Next, as illustrated in FIG. 16, the image processing apparatus 30 displays a medical image (step S51). The processing of displaying the medical image is realized by the medical image acquisition function 35a in the processing circuitry 35. Specifically, the image processing apparatus 30 displays the CT image acquired in step S11 on the display 32.

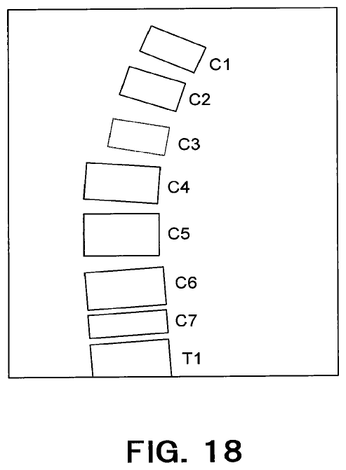

FIG. 18 is a diagram illustrating an example of a CT image displayed on the display 32 of the image processing apparatus 30 according to the present embodiment, and is a diagram corresponding to FIG. 9 in the above-described first embodiment. As illustrated in FIG. 18, the CT image displayed on the image processing apparatus 30 according to the present embodiment is a CT image regarding the spine including a plurality of vertebrae. In this CT image, for example, a spine number is allocated to each vertebra by detecting a physical feature of a subject by ALD and specifying each vertebra. Specifically, as illustrated in FIG. 18, spine numbers C1 to C7 and T1 are allocated to each vertebra of the displayed CT image. Note that, in the present embodiment, the spine number is allocated to each vertebra by performing ALD on the CT image, but the method of allocating the spine number to each vertebra is not limited thereto. That is, a method of allocating the spine number to each vertebra is arbitrary, and the image processing apparatus 30 may perform various image analysis on the CT image to allocate the spine number.

Next, as illustrated in FIG. 16, the image processing apparatus 30 receives an input operation of deleting the spine number from the user (step S53). The processing of receiving the input operation of deleting the spine number is realized by the reception function 35b in the processing circuitry 35. Specifically, the image processing apparatus 30 receives, from the user via the input interface 33, an input operation of deleting the spine number with respect to the CT image displayed on the display 32 in step S51.

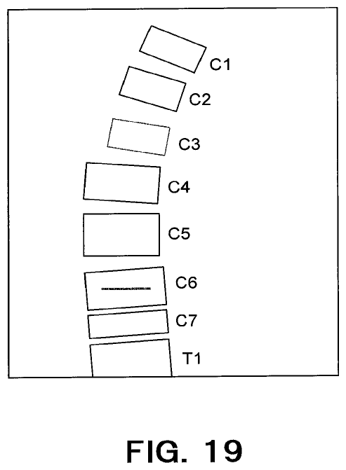

FIG. 19 is a diagram illustrating an example of an input operation of deleting the spine number received from the user with respect to the CT image displayed on the display 32 of the image processing apparatus 30 according to the present embodiment. As illustrated in FIG. 19, the image processing apparatus 30 receives an input operation of adding a minus sign to a position to which the spine number C6 is allocated in the CT image displayed on the display 32 from the user via a mouse or the like which is the input interface 33. A minus sign added to the CT image illustrated in FIG. 19 indicates a position where the input operation is received from the user.

Note that, in step S53, the image processing apparatus 30 receives the input operation of deleting the spine number from the user by adding the minus sign to the CT image by the user, but the input operation of deleting the spine number is not limited to the case of adding the minus sign to the CT image. That is, the operation of deleting the spine number is arbitrary, and for example, the image processing apparatus 30 may receive an input operation of deleting the spine number by the user by an input operation of right clicking the mouse as the input interface 33.

Next, as illustrated in FIG. 16, the image processing apparatus 30 acquires the designated position (step S55). The processing of acquiring the designated position is realized by the designated position acquisition function 35c in the processing circuitry 35. Specifically, the image processing apparatus 30 acquires information regarding the position of the designated position designated by the input operation of deleting the spine number in step S53. The position information regarding the designated position is, for example, XYZ coordinates of the designated position in the CT image.

Next, as illustrated in FIG. 16, the image processing apparatus 30 acquires anatomical landmark information in the vertebra at the designated position (step S57). The processing of acquiring the anatomical landmark information in the vertebra at the designated position is realized by the information acquisition function 35d in the processing circuitry 35. Specifically, the image processing apparatus 30 acquires anatomical landmark information in the vertebra at the designated position based on the designated position acquired in step S55.

Next, as illustrated in FIG. 16, the image processing apparatus 30 acquires anatomical landmark information in the vertebra adjacent to the vertebra at the designated position (step S59). The processing of acquiring the anatomical landmark information is realized by the information acquisition function 35d in the processing circuitry 35. Specifically, the image processing apparatus 30 acquires the anatomical landmark information in the vertebra adjacent to the vertebra at the designated position based on the information regarding the position of the designated position acquired in step S55. More specifically, in the example illustrated in FIG. 19, the image processing apparatus 30 acquires the anatomical landmark information in the vertebra to which the spine number C5 is allocated, which is located on the head side of the designated position represented by the minus sign, and the anatomical landmark information in the vertebra to which the spine number C7 is allocated, which is located on the lower limb side of the designated position represented by the minus sign.

Next, as illustrated in FIG. 16, the image processing apparatus 30 determines whether or not the designated position is located at a boundary between different regions in the spine (step S61). The processing of determining whether or not to be located at the boundary between the different regions is realized by the reception function 35b in the processing circuitry 35. Specifically, the image processing apparatus 30 determines whether or not the designated position acquired in step S55 is located at the boundary between the different regions based on the anatomical landmark information in the vertebra adjacent to the vertebra at the designated position acquired in step S59. More specifically, it is determined whether the spine numbers in the anatomical landmark information of the respective vertebrae located on the head side and the lower limb side of the designated position indicate the same region or different regions.

Then, in step S61, in a case where the designated position is not located at the boundary between the different regions in the spine (step S61: No), that is, in a case where the spine numbers in the anatomical landmark information of the vertebra adjacent to the vertebra at the designated position indicate the same region as illustrated in FIG. 19, the image processing apparatus 30 deletes the spine number (step S63). The processing of deleting the spine number is realized by the reception function 35b in the processing circuitry 35. Specifically, the image processing apparatus 30 deletes the spine number of the vertebra at the designated position acquired in step S55. More specifically, in the example illustrated in FIG. 19, the image processing apparatus 30 deletes the spine number C6 allocated to the vertebra at the designated position.

Next, as illustrated in FIG. 16, the image processing apparatus 30 determines whether or not the remaining spine number has been deleted (step S64). The processing of determining whether or not the remaining spine number has been deleted is realized by the reception function 35b in the processing circuitry 35. Specifically, the image processing apparatus determines whether or not the spine number deleted in step S63 is a remaining spine number. For example, in the T region, the spine numbers T1 to T12 are allocated, but in a case where the spine numbers T1 to T13 are allocated, the spine number T13 is the remaining spine number.

Then, in step S64, when the deleted spine number is the remaining spine number (step S64: Yes), the image processing apparatus 30 displays the spine number (step S65). The processing of displaying the spine number is realized by the reception function 35b in the processing circuitry Specifically, the image processing apparatus 30 reflects the deletion of the spine number executed in step S63 on the CT image displayed on the display 32, and displays the spine number. Accordingly, the deletion processing ends.

On the other hand, in step S64, when the deleted spine number is not the remaining spine number (step S64: No), the image processing apparatus 30 corrects the spine number (step S66). The processing of correcting the spine number is realized by the spine number correction function 35e in the processing circuitry 35. Specifically, the image processing apparatus 30 shifts the spine number of the vertebra at the deleted designated position based on the anatomical landmark information in the vertebra adjacent to the vertebra at the designated position to correct other spine numbers in the same region as the spine number of the vertebra at the deleted designated position. Here, the other spine numbers in the same region as the spine number of the vertebra at the deleted designated position are some or all spine numbers in the same region other than the spine number of the vertebra at the deleted designated position.

More specifically, in the example illustrated in FIG. 19, since the image processing apparatus 30 has deleted the spine number C6 of the vertebra at the designated position in step S63, in the C region which is the same region as the spine number C6 of the vertebra at the deleted designated position, the spine numbers allocated to the respective vertebrae are C1, C2, C3, C4, C5, and C7 in order from the head side. The image processing apparatus 30 compares the information regarding the position of the designated position with the information regarding the position of the anatomical landmark of the vertebra adjacent to the vertebra of the designated position, and determines that the probability that the spine number C7 of the sixth vertebra from the head side will be C6 is high since the spine number of the vertebra at the position close to the head side is C5, and shifts the spine number of the vertebra at the deleted designated position by one in the lower limb side direction in the C region which is the same region as the spine number C6 of the vertebra at the deleted designated position to correct the spine number C7 to the spine number C6.

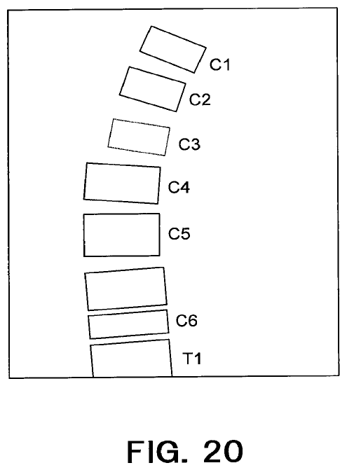

Next, as illustrated in FIG. 16, the image processing apparatus 30 displays the corrected spine number (step S67). The processing of displaying the corrected spine number is realized by the spine number correction function 35e in the processing circuitry 35. Specifically, the image processing apparatus 30 displays the spine number corrected in step S66 on the CT image displayed on the display 32. More specifically, as illustrated in FIG. 20, the image processing apparatus 30 displays the spine number C6 corrected in step S66 on the CT image displayed on the display 32 while reflecting the deletion of the spine number executed in step S63. Accordingly, the deletion processing ends.

On the other hand, in step S61, in a case where the designated position is located at the boundary between the different regions in the spine (step S61: Yes), that is, in a case where the spine number in the anatomical landmark information of the vertebra adjacent to the vertebra at the designated position indicates a different region, the image processing apparatus 30 generates options of the spine number as illustrated in FIG. 17 (step S69). The processing of generating the options of the spine number is realized by the reception function 35b in the processing circuitry 35. Specifically, the image processing apparatus 30 generates a plurality of options regarding the spine number of the vertebra at the designated position based on the anatomical landmark information in the vertebra at the designated position acquired in step S57 and the anatomical landmark information in the vertebra adjacent to the vertebra at the designated position acquired in step S59.

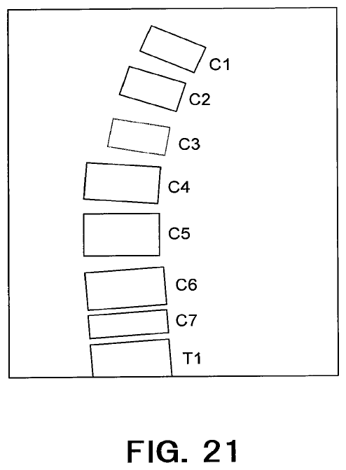

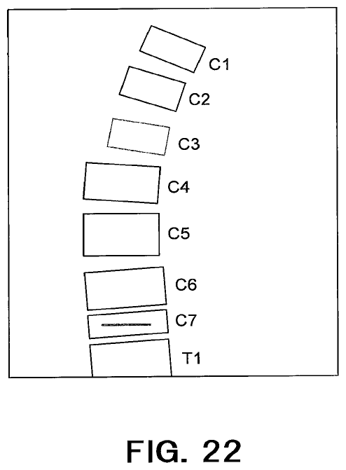

A case where the designated position according to the present embodiment is located at the boundary between the different regions in the spine will be described with reference to FIGS. 21 and 22. FIG. 21 is a diagram illustrating an example of a CT image displayed on the display 32 in a case where the designated position is located at the boundary between the different regions in the spine in the image processing apparatus according to the present embodiment. FIG. 22 is a diagram illustrating an example of the input operation of deleting the spine number received from the user with respect to the CT image in a case where the designated position is located at the boundary between the different regions in the spine in the image processing apparatus 30 according to the present embodiment. As illustrated in FIG. 21, spine numbers C1 to C7 and T1 are allocated to each vertebra of the displayed CT image. Furthermore, as illustrated in FIG. 22, the image processing apparatus 30 receives an input operation of deleting the spine number C7 with respect to a position between the spine number C6 and the spine number T1 from the user via a mouse or the like which is the input interface 33. In the example illustrated in FIG. 22, there is a possibility that the image processing apparatus 30 deletes the spine number as the spine number C7 or the spine number T1 based on the input operation of deleting the spine number received from the user and the anatomical landmark information in the vertebra adjacent to the vertebra at the designated position acquired in step S17. Therefore, in step S69, the image processing apparatus 30 generates options of the spine number C7 and the spine number T1 as a plurality of options of the spine number.

Note that the plurality of options regarding the spine number of the vertebra at the designated position generated in step S69 is not limited to two. That is, the number of the plurality of options for the spine number of the vertebra at the designated position to be generated is arbitrary, and three or more options may be generated.

Next, as illustrated in FIG. 17, the image processing apparatus 30 selects the spine number to be deleted (step S71). The processing of selecting the spine number to be deleted is realized by the reception function 35b in the processing circuitry 35. Specifically, the image processing apparatus 30 analyzes the CT image of the vertebra at the designated position acquired in step S55, thereby selecting the spine number to be deleted from the plurality of options generated in step S69. More specifically, as illustrated in FIGS. 3 to 5, the vertebral bodies Vb and the vertebral arches Va of the cervical vertebrae, the thoracic vertebrae, and the lumbar vertebrae have different sizes and shapes for respective regions of the cervical vertebrae, the thoracic vertebrae, and the lumbar vertebrae. Therefore, the size and/or shape of the vertebrae in each region of the C region, the T region, and the L region are different. Therefore, in step S71, the image processing apparatus 30 performs image analysis on the axial image to recognize which region of the C region, the T region, and the L region the vertebra at the designated position belongs to, and selects the spine number to be deleted.

Note that the image processing apparatus 30 analyzes the image to select the spine number to be deleted, but the method of selecting the spine number to be deleted is not limited thereto. That is, the method of selecting the spine number to be deleted is arbitrary. For example, the spine number to be deleted may be selected by comparing the information regarding the position in the anatomical landmark information of the plurality of options with the information regarding the probability. The selection of the spine number may be presented to the user as a selection screen, and the spine number to be deleted may be selected by receiving an input operation regarding the selection of the user. The image processing apparatus 30 may present a list of the spine numbers to the user, and select the spine number to be deleted by receiving an input operation regarding the selection of the user with respect to the presented list. The image processing apparatus 30 may display a text input box, and select the spine number to be deleted by causing the user to input the spine number to be deleted via the input interface 33.

Next, as illustrated in FIG. 17, the image processing apparatus 30 determines whether or not the selected spine number overlaps (step S73). The processing of determining whether or not the selected spine number overlaps is realized by the spine number correction function 35e in the processing circuitry 35. Specifically, the image processing apparatus 30 determines whether or not the selected spine number overlaps based on the anatomical landmark information in the vertebra adjacent to the vertebra at the designated position acquired in step S59.

Then, in step S73, in a case where the selected spine number does not overlap (step S73: No), the image processing apparatus 30 displays the options of the spine number (step S75). This processing of displaying the options of the spine number is realized by the spine number correction function 35e in the processing circuitry 35. Specifically, the image processing apparatus 30 displays the options of the spine number generated in step S69 while highlighting the spine number selected in step S71. Accordingly, the deletion processing ends.

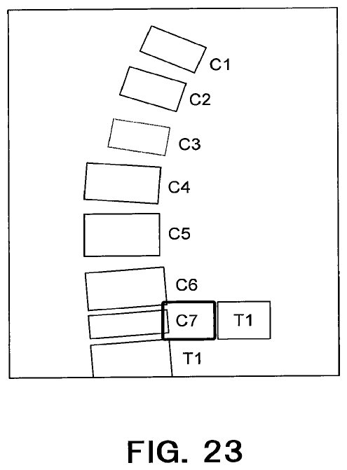

FIG. 23 is a diagram illustrating an example of a CT image in which the plurality of options is displayed in a case where the designated position is located at the boundary between the different regions in the spine in the image processing apparatus 30 according to the present embodiment. As illustrated in FIG. 23, on the display 32 of the image processing apparatus 30, the options of the spine number C7 and the spine number T1 are displayed as the spine number of the vertebra at the designated position, and the option of the spine number C7 selected in step S71 is emphasized. That is, in the example illustrated in FIG. 23, since the option of the spine number C7 is selected, the image processing apparatus 30 displays the options of the spine number C7 and the spine number T1 without correcting the other spine numbers in the C region.

On the other hand, in step S73, in a case where the selected spine number overlaps (step S73: Yes), the image processing apparatus 30 corrects the spine number (step S77). The processing of correcting the spine number is realized by the spine number correction function 35e in the processing circuitry 35. Specifically, the image processing apparatus 30 corrects the spine number located in the same region as the spine number selected in step S71.

More specifically, in the example illustrated in FIG. 22, in a case where the spine number T1 is selected in step S73 as the spine number of the vertebra at the designated position to be deleted, the spine numbers allocated to the vertebrae in the T region which is the same region as the selected spine number T1 are T1 and T1. That is, the spine number of the first vertebra in the T region from the head side and the spine number of the second vertebra in the T region from the head side overlap at T1. Therefore, the image processing apparatus 30 compares the information regarding the position of the designated position with the information regarding the position of the anatomical landmark of the vertebra adjacent to the vertebra of the designated position, and since the spine number of the vertebra of the T region at the position close to the head side is T1, the image processing apparatus 30 determines that the probability that the spine number of the vertebra of the second T region from the head side will be T2 is high, and corrects the spine number T1 allocated to the vertebra of the T region, which is the same region as the selected spine number T1, to T2.

Next, as illustrated in FIG. 17, the image processing apparatus 30 displays the options of the spine number and the corrected spine number (step S79). The processing of displaying the options of the spine number and the corrected spine number is realized by the spine number correction function 35e in the processing circuitry 35. Specifically, the image processing apparatus 30 displays the plurality of options of the spine number generated in step S69 and the spine number corrected in step S77 on the CT image while highlighting the spine number selected in step S71 among the plurality of options generated in step S69. More specifically, the image processing apparatus 30 displays the options of the spine number C7 and the spine number T1 while highlighting the spine number T1 selected in step S71, and displays the spine number in the T region corrected in step S77. Accordingly, the deletion processing ends.

As described above, according to the image processing apparatus 30 of the present embodiment, the image processing apparatus 30 acquires the medical image regarding the spine including the plurality of vertebrae, receives the input operation of editing the spine number allocated to the acquired medical image from the user, acquires the designated position designated by the input operation of editing the spine number received from the user, acquires the anatomical landmark information in the vertebra at the designated position and/or in the vertebra adjacent to the vertebra at the designated position based on the acquired designated position, and edits the spine number based on the acquired anatomical landmark information. Therefore, the spine number can be easily edited. That is, in the present embodiment, the image processing apparatus 30 receives, from the user, an input operation of deleting a spine number to a medical image regarding the spine including the plurality of vertebrae, acquires a designated position designated by the input operation of deleting the spine number received from the user, acquires anatomical landmark information in the vertebra at the designated position based on the acquired designated position, and deletes the spine number based on the acquired anatomical landmark information. Therefore, even when the gradation of the medical image is low and an incorrect spine number is allocated to the vertebra by ALD or the like, the spine number can be deleted.

Note that, in the image processing apparatus 30 according to the second embodiment described above, the input operation of automatically deleting the spine number is received from the user and the spine number is automatically deleted. However, the image processing apparatus 30 according to the second embodiment may receive the input operation of manually deleting the spine number from the user and manually delete the spine number. Specifically, the image processing apparatus 30 may receive an input operation of selecting a spine number and an input operation of deleting the selected spine number from the spine number allocated to the vertebra of the medical image displayed on the display 32 from the user, thereby manually deleting the spine number.

### Third Embodiment

In the image processing apparatus 30 according to the first embodiment described above, the input operation of adding the spine number is received from the user, the designated position designated by the input operation of adding the spine number received from the user and the anatomical landmark information in the vertebra adjacent to the vertebra at the designated position is acquired, and the spine number is added based on the input operation of adding the spine number and the anatomical landmark information in the vertebra adjacent to the vertebra at the designated position, but the editing of the spine number is not limited to the case of adding the spine number. Therefore, in the third embodiment, an image processing apparatus 30 that receives an input operation of moving the spine number from the user and moves the spine number to a predetermined position of the CT image will be described. Hereinafter, portions different from the above-described first embodiment will be described. Note that the configuration of an image processing system 1 according to the present embodiment is similar to that in FIG. 1, and thus the description thereof will be omitted. Furthermore, since the configuration of the image processing apparatus 30 according to the present embodiment is similar to that in FIG. 2, the description thereof will be omitted.

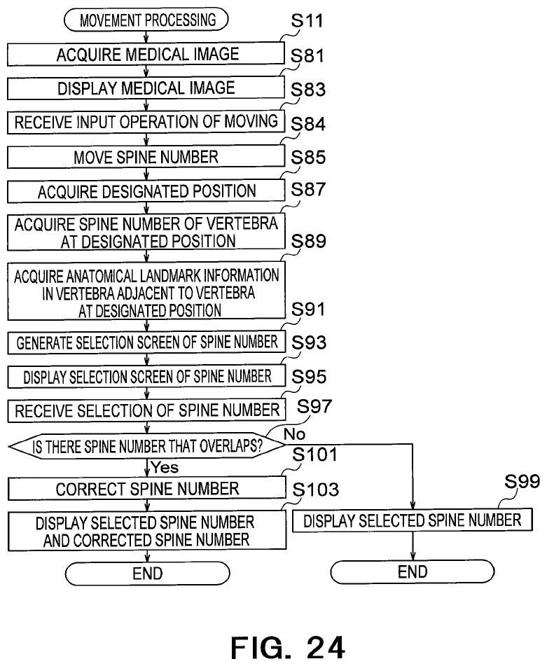

FIG. 24 is a flowchart illustrating the content of the movement processing executed by the image processing apparatus 30 according to the present embodiment, and is a diagram corresponding to FIGS. 7 and 8 in the above-described first embodiment. In this movement processing, an input operation of moving the spine number is received from the user, and the spine number is moved based on the input operation of moving the spine number received from the user. For example, this movement processing is processing executed when the user activates an edit program for editing the spine number allocated to the CT image. Note that the processing in step S11 illustrated in FIG. 24 is similar to that in FIG. 7 in the above-described first embodiment, and thus description thereof is omitted.

Next, as illustrated in FIG. 24, a medical image is displayed (step S81). The processing of displaying the medical image is realized by the medical image acquisition function 35a in the processing circuitry 35. Specifically, the image processing apparatus 30 displays the CT image acquired in step S11 on the display 32.

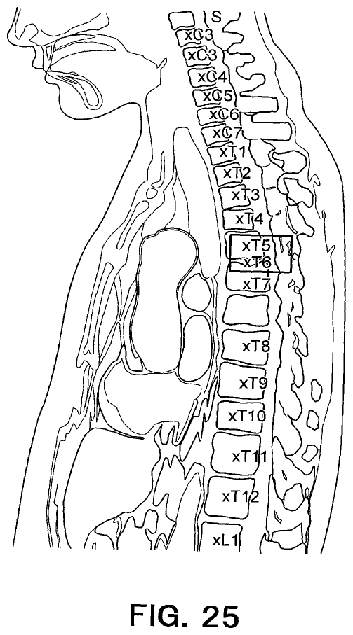

FIG. 25 is a diagram illustrating an example of a CT image displayed on the display 32 of the image processing apparatus 30 according to the present embodiment, and is a diagram corresponding to FIG. 9 in the above-described first embodiment. As illustrated in FIG. 25, the CT image displayed on the image processing apparatus 30 according to the present embodiment is a CT image regarding the spine including a plurality of vertebrae. In this CT image, for example, a spine number is allocated to each vertebra by detecting a physical feature of a subject by ALD and specifying each vertebra. Specifically, as illustrated in FIG. 25, spine numbers C3 to C7, T1 to T12, and L1 are allocated to each vertebra of the displayed CT image. In the example illustrated in FIG. 25, the spine number T5 and the spine number T6 are allocated to the same vertebra because ALD was not performed well at a position surrounded by the rectangular shape. Note that, in the present embodiment, the spine number is allocated to each vertebra by performing ALD on the CT image, but the method of allocating the spine number to each vertebra is not limited thereto. That is, a method of allocating the spine number to each vertebra is arbitrary, and the image processing apparatus 30 may perform various image analysis on the CT image to allocate the spine number.

Next, as illustrated in FIG. 24, the image processing apparatus 30 receives an input operation of moving the spine number from the user (step S83). The processing of receiving the input operation of deleting the spine number is realized by the reception function 35b in the processing circuitry 35. Specifically, the image processing apparatus 30 receives an input operation of moving the spine number in the CT image displayed on the display 32 in step S81 from the user via the input interface 33. The input operation of moving the spine number is, for example, a drag and drop operation using a mouse as the input interface 33.

Note that the input operation of moving the spine number is not limited to the drag and drop operation using the mouse. That is, the input operation of moving the spine number is arbitrary, and may be, for example, an operation of selecting the spine number to be moved and clicking a movement destination.

Next, as illustrated in FIG. 24, the image processing apparatus 30 moves the spine number (step S84). The processing of moving the spine number is realized by the reception function 35b in the processing circuitry 35. Specifically, the image processing apparatus 30 moves the spine number to a predetermined position based on the input operation of moving the spine number received from the user in step S83.

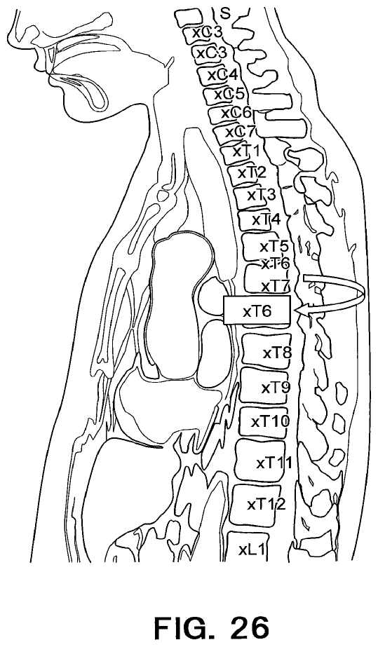

FIG. 26 is a diagram illustrating an example of an input operation of moving the spine number received from the user with respect to the CT image displayed on the display 32 of the image processing apparatus 30 according to the third embodiment. As illustrated in FIG. 26, the image processing apparatus 30 moves the spine number T6 to a position between the spine numbers T7 and T8 based on the input operation of moving the spine number T6 allocated to the same vertebra as the vertebra to which the spine number T5 received from the user is allocated.

Furthermore, in a case where the input operation of moving the spine number is received from the user in step S84, the image processing apparatus 30 may detect a range of the vertebra in the region around the position after the spine number is moved. Specifically, the image processing apparatus 30 may perform image processing based on the gradation of the pixel at the position after the movement of the spine number, and detect, in the region around the position after the movement of the spine number, a region of gradation within a range of a reference range based on the gradation of the pixel at the position after the movement of the spine number as the range of the vertebra.

Next, as illustrated in FIG. 24, the image processing apparatus 30 acquires the designated position (step S85). The processing of acquiring the designated position is realized by the designated position acquisition function 35c in the processing circuitry 35. Specifically, the image processing apparatus 30 acquires information regarding the position of the designated position, which is the position after the spine number is moved, designated by the input operation of moving the spine number received from the user in step S85. The position information regarding the designated position is, for example, XYZ coordinates of the designated position in the CT image.

Next, as illustrated in FIG. 24, the image processing apparatus 30 acquires the spine number of the vertebra at the designated position (step S87). The processing of acquiring the spine number of the vertebra at the designated position is realized by the information acquisition function 35d in the processing circuitry 35. Specifically, the image processing apparatus 30 acquires the spine number of the vertebra at the designated position, that is, the spine number moved to the designated position in step S83.

Next, as illustrated in FIG. 24, the image processing apparatus 30 acquires anatomical landmark information in the vertebra adjacent to the vertebra at the designated position (step S89). The processing of acquiring the anatomical landmark information is realized by the information acquisition function 35d in the processing circuitry 35. Specifically, the image processing apparatus 30 acquires the anatomical landmark information in the vertebra adjacent to the vertebra at the designated position based on the information regarding the position of the designated position acquired in step S85. More specifically, in the example illustrated in FIG. 26, the image processing apparatus 30 acquires the anatomical landmark information in the vertebra to which the spine number T7 is allocated, which is located on the head side of the designated position that is the position after the movement of the spine number T6, and the anatomical landmark information in the vertebra to which the spine number T8 is allocated, which is located on the lower limb side of the designated position.

Next, as illustrated in FIG. 24, the image processing apparatus 30 generates a selection screen of the spine number (step S91). The processing of generating the selection screen of the spine number is realized by the reception function 35b in the processing circuitry 35. Specifically, the image processing apparatus 30 generates the selection screen for allowing the user to select the spine number from a plurality of options regarding the spine number based on the spine number of the vertebra at the designated position acquired in step S87 and the anatomical landmark information in the vertebra adjacent to the vertebra at the designated position acquired in step S89. More specifically, in the image processing apparatus 30, in the example illustrated in FIG. 26, the spine numbers allocated to the respective vertebrae are T7, T6, and T8 in order from the head side. Therefore, the image processing apparatus 30 generates the selection screen for selecting the spine number T6 or T7 to be allocated to the vertebra at the designated position based on the spine number of the vertebra at the designated position and the anatomical landmark information in the vertebra adjacent to the vertebra at the designated position that is the position after the movement of the spine number.

Next, as illustrated in FIG. 24, the image processing apparatus 30 displays the selection screen of the spine number (step S93). The processing of displaying the selection screen of the spine number is realized by the reception function 35b in the processing circuitry 35. Specifically, the image processing apparatus 30 displays the selection screen generated in step S91. Note that when this selection screen is displayed, the image processing apparatus 30 may highlight the spine number having a high probability of being the spine number of the vertebra at the designated position.

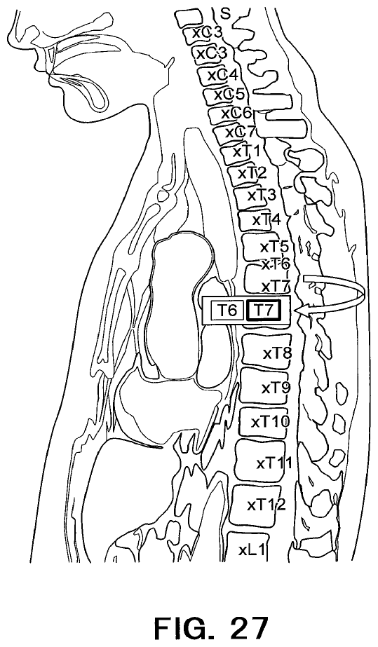

FIG. 27 is a diagram illustrating an example of a selection screen displayed on a CT image displayed on the display 32 of the image processing apparatus 30 according to the present embodiment. As illustrated in FIG. 27, the image processing apparatus 30 displays the selection screen including the spine number T6 and the spine number T7 as a plurality of options on the display 32. Furthermore, in the example illustrated in FIG. 27, the spine numbers allocated to the respective vertebrae are T7 and T6 or T7 and T8 in order from the head side. Therefore, the image processing apparatus 30 compares the information regarding the position of the designated position with the information regarding the position of the anatomical landmark of the vertebra adjacent to the vertebra of the designated position, and determines that the probability of the spine number T7 of the vertebra at the designated position is high because the designated position is closer to the head side than the position of the vertebra to which the spine number T8 is allocated, and the spine number T7 is displayed in a highlighted manner.

Next, as illustrated in FIG. 24, the image processing apparatus 30 receives selection of the spine number from the user (step S95). The processing of receiving the selection of the spine number is realized by the reception function 35b in the processing circuitry 35. Specifically, the image processing apparatus 30 receives the selection of the spine number from the user via the selection screen displayed in step S93. Then, the image processing apparatus 30 corrects the spine number of the vertebra at the designated position based on the selection of the spine number received from the user. More specifically, when receiving the selection of the spine number T7 from the user via the selection screen, the image processing apparatus 30 corrects the spine number T6 of the vertebra at the designated position to the spine number T7.

Next, the image processing apparatus 30 determines whether or not the spine number overlaps (step S97). The processing of determining whether or not the spine number overlaps is realized by the spine number correction function 35e in the processing circuitry 35. Specifically, the image processing apparatus 30 determines whether or not the spine number of which the selection is received from the user in step S95 overlaps based on the anatomical landmark information in the vertebra adjacent to the vertebra at the designated position acquired in step S89.

Then, in step S97, in a case where it is determined that the spine number does not overlap (step S97: No), the image processing apparatus 30 displays the selected spine number (step S99). The processing of displaying the selected spine number is realized by the spine number correction function 35e in the processing circuitry 35. Specifically, the image processing apparatus 30 displays the spine number selected, in step S95, by the user on the CT image displayed on the display 32 in step S81 via the selection screen. Accordingly, the movement processing ends.

On the other hand, in a case where it is determined in step S97 that the spine number overlaps (step S97: Yes), the image processing apparatus 30 corrects the spine number (step S101). The processing of correcting the spine number is realized by the spine number correction function 35e in the processing circuitry 35. Specifically, in step S95, the image processing apparatus 30 corrects other spine numbers allocated to the vertebra in the same region as the spine number selected from the user.

More specifically, in a case where the spine number T7 is selected in step S95, the spine numbers allocated to the respective vertebrae in the example illustrated in FIG. 27 are T7, T7, and T8 in order from the head side, and the spine numbers T7 overlap. Therefore, the image processing apparatus 30 compares the information regarding the position of the designated position with the information regarding the position of the anatomical landmark of the vertebra adjacent to the vertebra of the designated position, determines that the spine number T7 of the vertebra located on the head side of the spine number T7 of the vertebra at the designated position has a high probability of being the spine number T6, and corrects the spine number T7 to the spine number T6 such that the spine numbers allocated to the respective vertebrae in the example illustrated in FIG. 27 are T6, T7, and T8 in order from the head side.

Next, as illustrated in FIG. 24, the image processing apparatus 30 displays the selected spine number and the corrected spine number (step S103). The processing of displaying the selected spine number and the corrected spine number is realized by the spine number correction function 35e in the processing circuitry 35. Specifically, the image processing apparatus 30 displays the spine number for which the selection by the user has been received in step S95 and the spine number corrected in step S101 on the CT image displayed on the display 32. Accordingly, the movement processing ends.

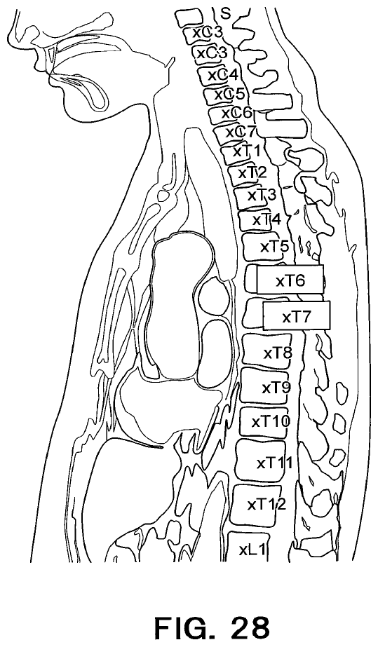

FIG. 28 is a diagram illustrating an example of a CT image in which the selected spine number and the corrected spine number are displayed in the image processing apparatus 30 according to the present embodiment. As illustrated in FIG. 28, on the display 32 of the image processing apparatus 30, the spine number T6 which is a corrected spine number and the spine number T7 which is a spine number selected at the designated position are displayed in the CT image in order from the head side.

As described above, according to the image processing apparatus 30 of the present embodiment, the image processing apparatus 30 acquires the medical image regarding the spine including the plurality of vertebrae, receives the input operation of editing the spine number allocated to the acquired medical image from the user, acquires the designated position designated by the input operation of editing the spine number received from the user, acquires the anatomical landmark information in the vertebra at the designated position and/or in the vertebra adjacent to the vertebra at the designated position based on the acquired designated position, and edits the spine number based on the acquired anatomical landmark information. Therefore, the spine number can be easily edited. That is, in the present embodiment, the image processing apparatus 30 receives, from a user, an input operation of moving a spine number to a medical image regarding a spine including the plurality of vertebrae, acquires a designated position, which is a position after the movement of the spine number, designated by the input operation of moving the spine number received from the user, acquires anatomical landmark information in the vertebra at the designated position or in the vertebra adjacent to the vertebra at the designated position based on the acquired designated position, generates a selection screen of the spine number for the vertebra after the movement based on the acquired anatomical landmark information, and receives, from the user, the selection of the spine number for the vertebra after the movement, thereby moving the spine number. Therefore, even when gradation of the medical image is low and an incorrect spine number is allocated to the vertebra by ALD or the like, the spine number can be moved to allocate the spine number to the correct position.

Note that, in the movement processing according to the third embodiment described above, the case where the selection screen of the spine number is generated and displayed on the display 32, and the selection of the spine number is received from the user via the selection screen of the spine number, whereby the spine number of the vertebra at the designated position is selected has been described. However, the method of selecting the spine number of the vertebra at the designated position is not limited thereto. For example, the image processing apparatus 30 may generate a plurality of options for the spine number of the vertebra at the designated position based on the spine number of the vertebra at the designated position and the anatomical landmark information in the vertebra adjacent to the vertebra at the designated position, and select the spine number of the vertebra at the designated position from the plurality of options based on the anatomical landmark information in the vertebra adjacent to the vertebra at the designated position. Specifically, the image processing apparatus 30 may select the spine number of the vertebra at the designated position from the plurality of options by comparing the information regarding the position of the designated position with the information regarding the position of the anatomical landmark of the vertebra adjacent to the vertebra at the designated position. Furthermore, the image processing apparatus 30 may present a list of spine numbers to the user, and may select the spine number by receiving an input operation regarding selection of the user with respect to the presented list, and the image processing apparatus 30 may display a text input box and cause the user to input the spine number via the input interface 33 to select the spine number.

### [First Modification of First to Third Embodiments]

In the first to third embodiments described above, the X-ray CT apparatus has been described as an example of the medical image diagnostic apparatus, but the medical image diagnostic apparatus is not limited to the X-ray CT apparatus. That is, the medical image diagnostic apparatus in the first to third embodiments described above is arbitrary, and may be another medical image diagnostic apparatus such as an MRI apparatus. Furthermore, in the first to third embodiments described above, the CT image acquired by the X-ray CT apparatus has been described as an example of the medical image, but the medical image is not limited to the CT image. That is, the medical image in the first to third embodiments described above is arbitrary, and may be, for example, another medical image acquired by another medical image diagnostic apparatus, such as an MR image acquired by an MRI apparatus.

### [Other Modifications of First to Third Embodiments]

In the first to third embodiments described above, regarding the edited and/or corrected spine number and anatomical landmark, the user can add the information to another system, for example, a reporting system.

Furthermore, in the first to third embodiments described above, the image processing apparatus 30 can save the edited and/or corrected spine number or anatomical landmark by overwriting and saving the edited and/or corrected spine number or anatomical landmark in a file generated by the user in another system or by saving the edited and/or corrected spine number or anatomical landmark in a file having the same data format as the data format when newly acquired from another apparatus. Furthermore, the information can be transmitted to the medical image storage apparatus 20 again thereafter.

Moreover, in a case where a spine number or anatomical landmark is generated from the present apparatus, the edited and/or corrected spine number or anatomical landmark can be stored in a private tag of a DICOM tag of a medical image such as a CT image acquired from the medical image diagnostic apparatus 10 or the medical image storage apparatus 20 or in a data format of another apparatus that performs image analysis and performs spine number allocation.

Note that the word “processor” used in above descriptions means circuits such as, for example, a Central Processing Unit (CPU), a Graphics Processing Unit (GPU), an Application Specific Integrated Circuit (ASIC), a programmable logic device (for example, a Simple Programmable Logic Apparatus (SPLD), a Complex Programmable Logic Apparatus (CPLD), and a Field Programmable Gate Array (FPGA)). The processor executes functions by reading and executing programs stored in the memory. Note that programs may be configured to be directly integrated in the processor instead of being storing in the memory. In this case, the processor realizes functions by reading and executing programs stored in the circuit. Note that the processor is not limited to the case arranged as a single processor circuit, but may be configured as a single processor by combining a plurality of independent circuits to realize functions. Furthermore, a plurality of component elements may be integrated into one processor to realize the functions.

While certain embodiments have been described, these embodiments have been presented by way of example only and are not intended to limit the scope of the inventions. The embodiments may be in a variety of other forms. Furthermore, various omissions, substitutions and changes may be made without departing from the spirit of the inventions. The embodiments and their modifications are included in the scope and the subject matter of the invention, and at the same time included in the scope of the claimed inventions and their equivalents.

1. An image processing apparatus comprising:
processing circuitry configured to
acquire a medical image regarding a spine including a plurality of vertebrae,
receive, from a user, an input operation of editing a spine number allocated to each of the vertebrae in the medical image, and
correct the spine number other than the spine number edited based on the received input operation.

2. The image processing apparatus of claim 1, wherein the processing circuitry is further configured to
acquire a designated position in the medical image, wherein the designated position is designated by the input operation,
acquire, based on the acquired designated position, anatomical landmark information that is information regarding anatomical landmarks in the vertebra at the designated position and/or in the vertebra adjacent to the vertebra at the designated position, and
edit the spine number of the vertebra at the designated position based on the received input operation and the acquired anatomical landmark information.

3. The image processing apparatus of claim 2, wherein the processing circuitry is further configured to
acquire the designated position in the medical image, wherein the designated position is designated by the input operation of adding the spine number,
acquire anatomical landmark information in the vertebra adjacent to the vertebra at the designated position, and
add the spine number of the vertebra at the designated position based on the input operation and the acquired anatomical landmark information.

4. The image processing apparatus of claim 2, wherein the processing circuitry is further configured to
determine whether or not there is a vacancy in the spine number based on the anatomical landmark information in the vertebra adjacent to the vertebra at the designated position,
when there is a vacant in the spine number, add the vacant spine number as the spine number of the vertebra at the designated position, and
when there is no vacancy in the spine number, shift and add the spine number in the vertebra adjacent to the vertebra at the designated position as the spine number of the vertebra at the designated position.

5. The image processing apparatus of claim 4, wherein the processing circuitry is further configured to
when the spine number is shifted, with reference to the added spine number of the vertebra at the designated position, correct other spine numbers located on a side of the spine number overlapping the spine number of the vertebra at the designated position and in a same region as the added spine number of the vertebra at the added designated position, and
display the added spine number of the vertebra at the added designated position and the corrected spine numbers.

6. The image processing apparatus of claim 3, wherein the processing circuitry is further configured to
determine whether or not the designated position is located at a boundary between different regions in the spine based on the anatomical landmark information,
when the designated position is located at the boundary between the different regions, generate a plurality of options regarding the spine number of the vertebra at the designated position based on the anatomical landmark information in the vertebra adjacent to the vertebra at the designated position, and
select the spine number to be added from the plurality of generated options.

7. The image processing apparatus of claim 6, wherein the processing circuitry is further configured to
when the selected spine number overlaps with the spine number in the anatomical landmark information of the vertebra adjacent to the vertebra at the designated position, correct the spine number located in a same region as the selected spine number, and
display the plurality of options regarding the spine number and the corrected spine number.

8. The image processing apparatus of claim 2, wherein the processing circuitry is further configured to
acquire the designated position in the medical image, wherein the designated position is designated by the input operation of deleting the spine number,
acquire anatomical landmark information of the vertebra at the designated position, and
delete the spine number of the vertebra at the designated position based on the input operation and the acquired anatomical landmark information.

9. The image processing apparatus of claim 8, wherein the processing circuitry is further configured to
Acquire the anatomical landmark information in the vertebra adjacent to the vertebra at the designated position, and
based on the anatomical landmark information in the vertebra adjacent to the vertebra at the designated position, shift the spine number of the vertebra at the designated position to correct other spine numbers in a same region as the deleted spine number of the vertebra at the designated position, and display the corrected spine numbers.

10. The image processing apparatus of claim 9, wherein the processing circuitry is further configured to
determine whether or not the designated position is located at a boundary between different regions in the spine based on the anatomical landmark information,
when the designated position is located at the boundary between the different regions, generate a plurality of options regarding the spine number of the vertebra at the designated position based on the anatomical landmark information in the vertebra at the designated position and the anatomical landmark information in the vertebra adjacent to the vertebra at the designated position, and
select the spine number to be deleted from the plurality of generated options.

11. The image processing apparatus of claim 10, wherein the processing circuitry is further configured to
when the selected spine number overlaps with the spine number in the anatomical landmark information in the vertebra adjacent to the vertebra at the designated location, correct other spine numbers located in a same region as the selected spine number, and
display the plurality of options regarding the spine number and the corrected spine numbers.

12. The image processing apparatus of claim 2, wherein the processing circuitry is further configured to move the spine number based on the input operation of moving the spine number.

13. The image processing apparatus of claim 12, wherein the processing circuitry is further configured to
acquire the designated position that is a position after movement of the spine number,
acquire the spine number at the designated position and the anatomical landmark information of the vertebra adjacent to the vertebra at the designated position that is the position after movement of the spine number, and
based on the spine number at the designated position and the anatomical landmark information of the vertebra adjacent to the vertebra at the designated position that is the position after the movement of the spine number, generate a plurality of options regarding the spine number of the vertebra at the designated position that is the position after the movement of the spine number.

14. The image processing apparatus of claim 13, wherein the processing circuitry is further configured to
generate and display a selection screen for allowing the user to select the spine number from the plurality of options regarding the spine number, and
receive selection of the spine number via the selection screen.

15. The image processing apparatus of claim 13, wherein the processing circuitry is further configured to select the spine number of the vertebra at the designated position after the movement from the plurality of options based on the anatomical landmark information in the vertebra adjacent to the vertebra at the designated position.

16. The image processing apparatus of claim 13, wherein the processing circuitry is further configured to
determine, based on the anatomical landmark information adjacent to the vertebra at the designated position, whether or not there is the spine number that overlaps with the spine number of the vertebra at the designated position,
when there is the spine number that overlaps with the spine number of the vertebra at the designated position, correct the overlapping spine number based on the anatomical landmark information adjacent to the spine number of the vertebra at the designated position, and
display the spine number of the vertebra at the designated position and the corrected spine number.

17. The image processing apparatus of claim 7, wherein the processing circuitry is further configured to display one of the spine numbers among the plurality of options in a highlighted manner.
